(19) United States
(12) Patent Application Publication
(10) Pub. No.: US 2017/0173552 A1
(43) Pub. Date: Jun. 22, 2017

(54) CONVERSION OF VIBRATIONAL ENERGY

(71) Applicants: MASSACHUSETTS INCTITUE OF TECHNOLOGY, Cambridge, MA (US); SRI INTERNATIONAL, Menlo Park, CA (US)

(72) Inventors: Peter L. HAGELSTEIN, Carlisle, MA (US); Michael MCKUBRE, Menlo Park, CA (US); Jianer BAO, Sunnyvale, CA (US); Francis L. TANZELLA, San Carlos, CA (US)

(21) Appl. No.: 15/127,752

(22) PCT Filed: Mar. 20, 2015
(86) PCT No.: PCT/US2015/021743

§ 371 Date: Sep. 20, 2016

Related U.S. Application Data
(60) Provisional application No. 61/955,908, filed on Mar. 20, 2014.

(51) Int. Cl. B01J 19/10; G21H 1/00; H05G 2/00

(52) U.S. Cl. CPC B01J 19/10; H05G 2/00; G21H 1/00; B01J 2219/0879

(57) ABSTRACT

The present application discloses methods and apparatus for conversion of quantized vibrational energy. The present application discloses, by driving a medium that comprises arranged nuclei with one or more selected driving frequencies, the arranged nuclei in the medium are induced to oscillate coherently at one or more oscillating frequencies. The mechanical vibrational energy of the oscillating nuclei interacts with the oscillating medium. The interaction between the vibrational energy and the oscillating medium effectuates up-conversion or down-conversion of quantized vibrational energy.

### RELATED APPLICATIONS

The present application claims priority to the U.S. Provisional Application 61/955,908 filed on Mar. 20, 2014, the content of which is incorporated herein in its entirety.

### TECHNICAL FIELD

The present application relates generally to conversion of vibrational energy and, more specifically, to vibrationally-induced emission sources.

### BACKGROUND

According to the well-known wave-particle duality theory, matter or energy can exhibit characteristics of both waves and particles. For example, light beams can generate interference patterns like waves, and at the same time, can behave like particles that carry a quantum of energy. In the famous photoelectric experiment, electrons are observed to escape from the surface of a piece of metal when light of frequencies above a certain threshold shines on the metal. Classic electromagnetic theory in which light beams are treated as waves cannot explain why only lights of certain frequencies can cause photoelectric effects. The explanation suggested by Albert Einstein, for which he won the Nobel Prize, attributes the photoelectric effect to the particle characteristics of light. Light of different frequencies are particles of different energies. Only particles of sufficient energy can transfer enough energy to the free electrons in the metal when the electrons absorb the light particles, to allow the electrons to overcome the surface energy barrier of the metal and break free.

An effect analogous to the photoelectric effect is expected to occur when the electrons (or other conduction charges) in a piece of metal absorb a quantum of energy from other sources. The energy quanta absorbed by the electrons can enable the electrons to rise either above the vacuum level (where emission occurs) or just below the vacuum level (where charge transfer occurs in collisions with air molecules). The other sources of energy may include vibrational energy.

More than a decade ago, in an experiment now known as the Karabut experiment, Karabut observed collimated X-ray emissions near 1.5 keV in his high-current density glow discharge experiment. Collimated X-ray emission in subsequent studies was observed to occur in bursts for up to a millisecond after the discharge had been turned off. This result was unexpected and difficult to understand. One reason that the Karabut experiment is difficult to understand is that, to obtain collimated X-rays, either an X-ray laser source is needed or some type of phase coherence must be present among the dipole radiators.

However, both the level of energy in the observed X-rays and the time period for which the collimated X-ray emission was observed to last indicate that the source of the collimated X-rays observed in the Karabut experiment is not due to a population inversion from a low energy level to a high energy level. That is, collimated X-ray emission observed in the Karabut experiment cannot be due to an X-ray laser source.

Consequently the only possibility for the collimated X-ray radiation is due to phase coherence among dipole radiators. However, there still remains the question of how phase coherence over a macroscopic region of the cathode surface used in the Karabut experiment can be achieved. Logically, the only possible way that this might occur is there might be a large scale up-conversion of vibrational quanta. Vibrational quanta are quantized vibrational energy. However, the vibrational quanta present in the Karabut experiment are probably at or below a micro electron volt, which is much less than the larger 1.5 keV quantum of the collimated x-rays. A conclusion that follows from this is that there must be a mechanism present that allows large scale up-conversion of the vibrational quanta in the Karabut experiment. Up-conversion of up to about 10,000 quanta is observed in high harmonic generation experiments, which occurs through a known mechanism (Corkum's mechanism) and is known to be not operative in the Karabut experiment. Therefore, some other mechanism must be responsible for the up-conversion of vibrational quanta in the Karabut experiment. This new mechanism may be capable of both up-conversion and down-conversion of vibrational quanta, allowing for coherent energy exchange between a vibrational mode and nuclear and electronic degrees of freedom.

In one theoretical model, it is proposed that the collimated X-ray emission in the Karabut experiment is due to nuclear excitation between a ground state and an excited state. A systematic search of all known excited states among the stable nuclei leads to the conclusion that the only candidate nuclear transition possible is in a ²⁰¹Hg nucleus, which has an excited state at 1.565 keV. Different models indicate that the collimated X-ray emission can be produced by a small amount of impurity Hg on the cathode surface, at levels consistent with endemic background contamination levels.

In search of different devices that can reproduce the up-conversion effect of vibrational quanta as observed in the Karabut experiment, novel and inventive apparatus and methods are investigated and developed.

### SUMMARY

The present application discloses devices and methods for converting quantized vibrational energy into another form of energy (up-conversion of quanta) or converting another form of energy into quantized vibrational energy (down-conversion of quanta) through interaction between vibrational energy and an oscillating medium.

In some embodiments, an apparatus for up-converting or down-converting quanta is disclosed. The apparatus comprises a driver and a medium. The driver is configured to generate oscillations of one or more driving frequencies. The medium comprises arranged nuclei configured to oscillate at one or more oscillating frequencies. Due to the interaction between the mechanical vibrational energy of the oscillating nuclei and the oscillating nuclei, the vibrational quanta in the oscillating nuclei are up-converted or down-converted.

In some embodiments, the vibrational quanta are up-converted to produce excitation in nuclei, which subsequently decay exothermically leading to heat generation. In some embodiments, the vibrational quanta are up-converted to produce excitation in nuclei, which subsequently decay to produce collimated x-rays that can be used for different applications

In some embodiments, the vibrational quanta are up-converted into electronic energy. In these embodiments, the mechanical vibrational energy of the oscillating nuclei is converted into the energy of the conduction charges (e.g., electrons or holes). In some embodiments, one or more of the energized conduction charges may overcome the surface energy barrier of the medium. In some embodiments, one or more of the energized conduction charges may become available for charge transfer to atoms or molecules that come in contact with the surface of the medium.

In some embodiments, the vibrational quanta are down-converted. In these embodiments, nuclear energy or electronic energy of the nuclei that are participating in the oscillations is converted into the mechanical vibrational energy of the oscillations.

In some embodiments, the driver is connected to a signal generator that generates a signal of a selected frequency. The medium is a metal plate. The signal generator applies a drive voltage between the driver and the metal plate, creating an electrostatic coupling between the driver and the metal plate. When the selected frequency is set to be one half of a resonant frequency of the metal plate, the metal plate is induced to vibrate at the resonant frequency. The quantized vibrational energy of the metal plate may be up-converted into the energy of the conduction charges in the metal plate. The conduction charges may comprise electrons and/or holes. When the energy of the conduction charges is high enough to enable the conduction charges to overcome the surface energy barrier of the metal plate, the metal plate becomes an emission source of charges.

In some embodiments, the emitted charges are collected by a collector. In some embodiments, the emitted charges comprise energetic electrons. The energetic electrons can be used as catalyst for acceleration of chemical reactions. The emitted charges can also be used to generate excitations in a fluorescent material, which may find useful applications in display devices.

### BRIEF DESCRIPTION OF THE DRAWINGS

FIG. 1 illustrates an exemplary apparatus configured as a vibrationally-induced emission source.

FIG. 2 illustrates an exemplary driver configured to generate oscillations in a medium.

FIG. 3 illustrates an exemplary resonator assembly configured to vibrate when driven by a driver.

FIG. 4 illustrates an exemplary apparatus configured for generating and measuring vibrationally-induced emitted charges.

FIGS. 5A-5D illustrate measurement results of the charges emitted from a vibrationally-induced emission source.

FIG. 6 illustrates an exemplary apparatus configured for converting vibrational energy.

FIG. 7 is a flow chart illustrating an exemplary method of converting vibrational energy.

### DETAILED DESCRIPTION

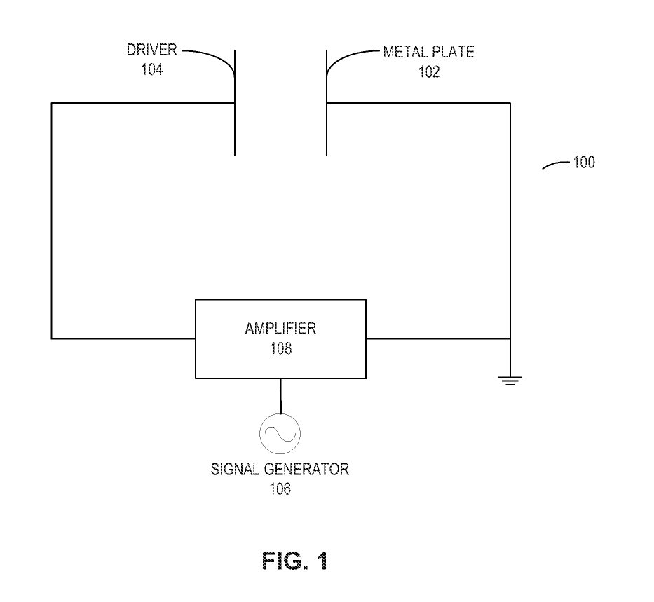

FIG. 1 illustrates an exemplary apparatus 100 configured to up-convert or down-convert quantized vibrational energy into the energy of the electrons in a metal plate 102. The apparatus 100 comprises a driver 104, a metal plate 102, a signal generator 106, and an amplifier 108. The signal generator 106 is connected to the driver 104 via the amplifier 108. The metal plate 102 is grounded. The driver 104 and the metal plate 102 form an air capacitor.

The signal generator 106 is configured to generate signals for driving the driver 104. The driving signals generated by the signal generator 106 may comprise signals of one or more frequencies. In some embodiments, an Agilent 8648A RF Function generator is used to generate radio signals from 1 to 61 MHz, and an ENI 603L 3-W linear amplifier is used as the amplifier 108 to amplify the driving signals. In one embodiment, a power gain of 40 dB is achieved by the amplifier 108. The driving signal applies a driving voltage between the driver 104 and the grounded metal plate 102, creating an electrostatic coupling between the driver and the metal plate 102. Because of the electrostatic coupling, the metal plate 102 is induced to vibrate in response to the driving signal.

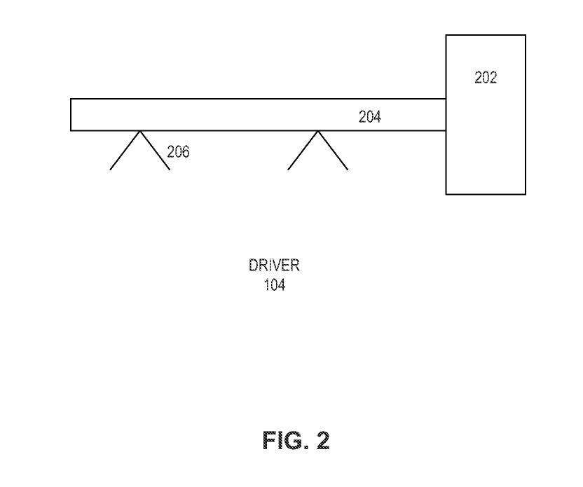

In some embodiments, when the driving frequencies are set to one or more selected values, the quantum effect of the vibrational energy of the metal plate is manifested. The apparatus 100 is configured to convert the quantized vibrational energy into the energy of the electrons in the metal plate. In these embodiments, the driver 104 in the apparatus 100 is constructed using a thick cylinder 202 connected to a rod 204, as shown in FIG. 2. In one embodiment, the cylinder 202 is 0.250 inches thick and 0.750 inches in diameter. The rod 204 is made of solid copper and is 0.250 inches in diameter and 4.00 inches long. The rod 204 is supported by four legs 206, each 0.125 inches long.

The metal plate 102 is made of copper foil and is in the shape of a circle. In one embodiment, the thickness of the copper foil is between 72 and 73 microns and the diameter of the copper foil is approximately 1.5 inches. However, the copper foil can be made of a different thickness, for example, between 10-200 microns. The metal plate 102 may be made of rolled or annealed copper.

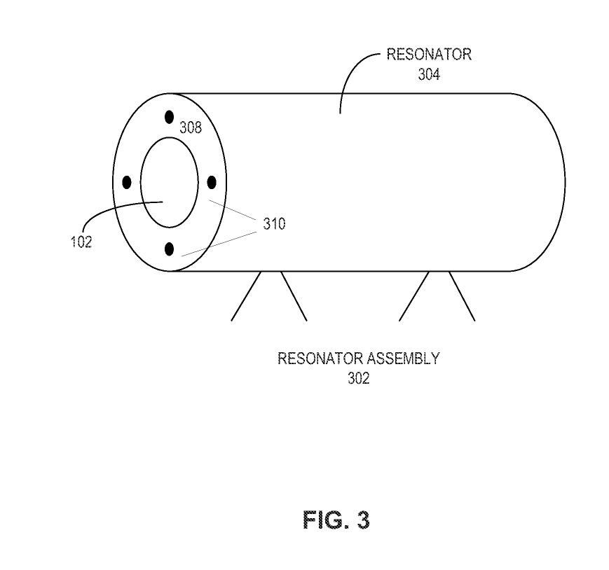

As an enhancement, a resonator 304 may be attached to the metal plate 102 as shown in FIG. 3. In FIG. 3, the resonator assembly 302 comprises the metal plate 102 and the resonator 304 supported by four legs 312. The resonator 304 comprises a pipe 306 and a washer 308. The pipe 306 is two inches long, with an outer diameter of 1.50 inches and an inner diameter of 0.85 inches. The washer 308 is 0.125 inches thick with an outer diameter and an inner diameter that match the outer and inner diameter of the pipe 306. Four equally spaced screws 310 affix the metal plate 102 to the washer 308.

When the signal generator 106 is turned on, through the electrostatic coupling between the driver 104 and the resonator assembly 302, the resonator assembly 302 is induced to vibrate in response to the driving signal. Mechanical vibrations in the resonator assembly 302 are driven by the force exerted on the metal plate 102. The force is due to the electric field between the driver 104 and the metal plate 102. As an approximation, the driver 104 and the resonator assembly 302 can be treated as an air capacitor with two parallel plates. The electric field in between the plates can be viewed as normal to the surfaces of the plates and of a uniform magnitude. Near the edges of the plates, the magnitude of the electric field falls off quickly. Under the assumption that the driver 104 and the resonator assembly 302 form a uniform planar capacitor, the force exerted on the resonator assembly 302 can be expressed as:

$$F = - \frac{\partial }{\partial d} {( \frac{A ɛ {V}^{2}}{2 d} )}^{2} = \frac{A ɛ {V}^{2}}{2 d} , \qquad Eq ( 1 )$$

where A is the area of the planar capacitor, d is the distance between the parallel plates of the planar capacitor, ε is the dielectric coefficient, and V is the driving voltage applied to the capacitor by the signal generated by the signal generator 106. As can be seen in Eq (1), the force exerted on the resonator assembly 302 is proportional to V². Therefore, the frequency of the force (or the frequency of a component of the force) is twice the frequency of the driving voltage. It is noted that in embodiments in which a DC offset is included in the driving voltage, a component of the force is proportional to V multiplied by the DC offset. In such case, the frequency of that force component is the same as the frequency of the driving voltage. Because the force drives the vibration of the resonator plate, herein the frequency of the force is referred to as the driving frequency. It is noted that the driving frequency may be twice the frequency of the signal generated by the signal generator 106. The frequency at which the resonator assembly 302 vibrates is referred to as the oscillating frequency of the resonator assembly 302.

When the driving frequency matches one of the resonant frequencies of the resonator assembly 302, the resonator assembly 302 vibrates in one of the resonant modes. The resonant modes of the resonator assembly 302 include fundamental compressional modes in which the resonator assembly 302 vibrates along the longitudinal axis of the resonator 304. The resonant modes of the resonator assembly 302 also include fundamental transverse modes in which the vibrations are along the radial direction. The resonant modes also include combinations of the fundamental compressional modes and transverse modes.

The vibrational movements of the metal plate 102 can be approximated using an elastic model:

$$ρ \frac{{\partial }^{2}}{\partial t} u = ( λ + μ ) {∇}^{2} u - μ ∇ \times ( ∇ \times u ) + f , \qquad Eq ( 2 )$$

where u is the displacement of a point (any point) on the metal plate 102, ρ is the density of the metal plate at that point, λ and μ are elastic constants, and f is the force density. In Eq (2), term (λ+μ)∇²u represents the compressional movements and term −μ∇×(∇×u) represents the transverse movements of the metal plate 102.

The frequencies of the fundamental compressional modes can be expressed as

$${ω}_{n} = \frac{n π c}{2 d} ,$$

where n is the order of the resonant mode and c is the speed of the mechanical waves traveling across the metal plate 102. The frequencies of the transverse modes can be expressed as ω=\sqrt{c²[kₓ²+k_{y}²]} with kₓ and k_{y} representing components of a wave vector along the x and y directions (i.e., two perpendicular radial directions) respectively.

When the resonator assembly 302 vibrates in a resonant mode, the different parts of the resonator plate move coherently and the vibrational energy is maximized within the vicinity of the resonant mode (i.e., a local maximum). In some embodiments, when the signal generator 106 is configured to generate a signal of frequency v with v being half of a resonant frequency of the metal plate 102, the metal plate 102 is induced to vibrate in the resonant mode having a resonant frequency 2v. When in a resonant mode, the quantum effect of the vibrational energy of the metal plate 102 may be manifested and the vibrational quanta may be converted into the electronic energy of the conduction charges in the metal plate 102. Examples of the conduction charges include electrons. In some cases, when the vibrational energy of the metal plate 102 is converted into the energy of the electrons, one or more of the energized electrons may overcome the surface energy barrier of the metal plate 102 and break free from the metal plate 102. It is noted that in some embodiments in which the plate 102 is made of semiconductor instead of metal, the conduction charges may be holes. In these embodiments, one or more of the promoted or excited holes may transfer charges to atoms or molecules that come in contact with the surface of the medium.

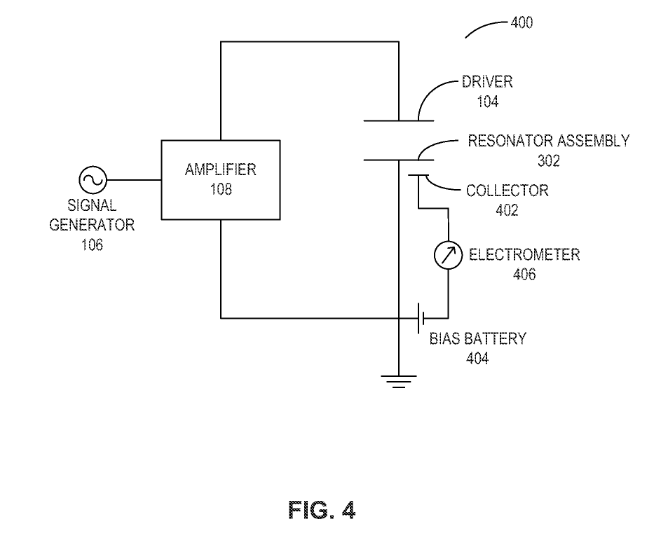

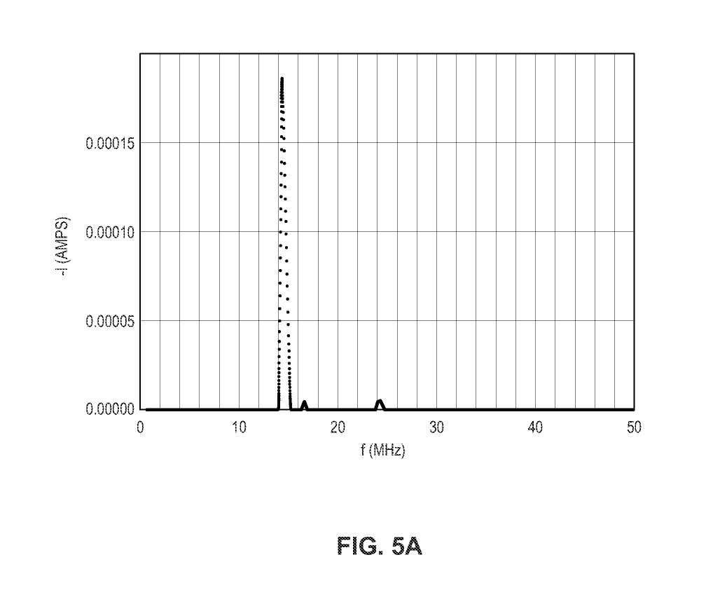

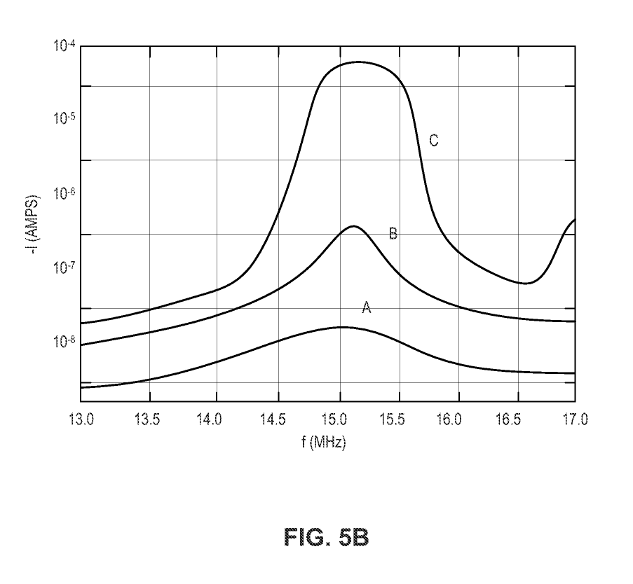

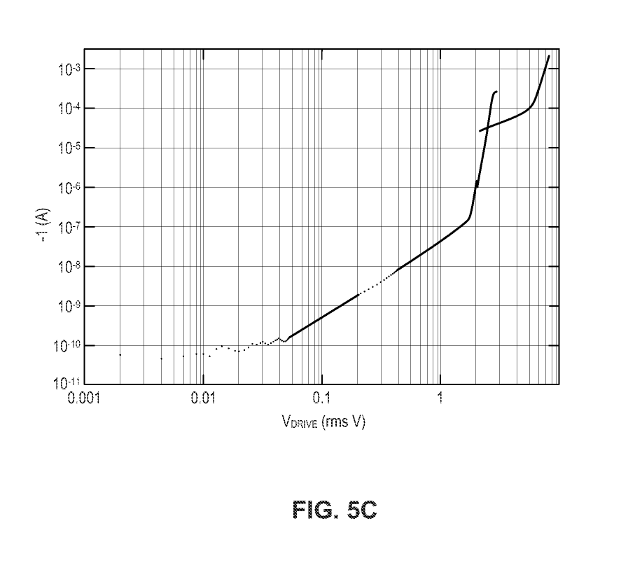

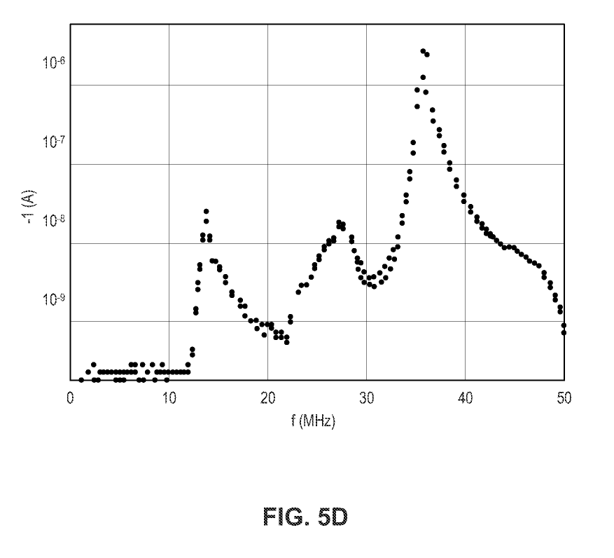

To collect the electrons emitted by the metal plate 102, a collector 402 may be placed near the resonator assembly 302 as shown in FIG. 4. The collector 402 is connected to an electrometer 406 that measures the strength of the electron stream emitted by the metal plate 102. A bias voltage 404 is applied between the resonator assembly 302 and the collector 402 to measure the energy of the emitted electrons. In some embodiments, the conduction charges emitted by the metal plate 102 are not necessarily negative charges. For example, when the plate 102 is made of p-type semiconductor instead of metal, the plate 102 may excite holes, which can lead to positive charge transfer to molecules in the air coming into contact with the plate 102. The bias voltage 404 can be used to measure the polarity of the emitted charges. FIGS. 5A-5D show the results as measured by the electrometer 406 under different conditions.

FIG. 5A illustrates the negative current registered by the electrometer 406 −I(amps) as a function of the driving frequency f (MHz). The drive voltage is 3V rms. In FIG. 5A, the strongest emission occurs at 15.1 MHz, which corresponds to the second order transverse mode of the resonator assembly 302. Three other weak or modest emissions lines are also recorded at 17.4 MHz, 22.5 MHz, and 24 MHz. The driving frequency of 17.4 MHz corresponds to the first order compressional mode. The driving frequencies of 22.5 MHz and 24 MHz correspond to the third order transverse mode, with the latter frequency being shifted due to spatial modulation or localization.

FIG. 5B illustrates a high resolution diagram of the emission line near 15.1 MHz. The three different curves, A, B, and C, represent the results obtained under three different drive voltages. Curve A represents the current measured by the electrometer 406 when the drive voltage is set to 1V rms. Curve B represents the measured current when the drive voltage is set to 2V rms, and curve C, 3V rms. It can be seen from FIG. 5B that the current as measured by the electrometer 406 is a strong function of the drive voltage. When the drive voltage increases from 1V rms to 3V rms, the measured current increases by a factor of 3500. Also in FIG. 5B, the emission line near 17.4 MHz only appears on curve C when the drive voltage is the highest.

FIG. 5C illustrates the relationship between the current measured by the electrometer 406 and the drive voltage. As shown in FIG. 5C, the current goes up when the drive voltage increases. The three segments in the curve of FIG. 5C represent three data sets that correspond to different range settings in the electrometer 406. Between 0.05V and 1.5V of the drive voltage, the current is proportional to the square of the drive voltage. When the drive voltage is higher than 1.5V, the current increases more rapidly. In the last segment of the curve, the rate at which the current increases is reduced because of the charges built up at the electrometer 406. In FIG. 5C, at a high drive voltage (>1.5V rms), the current can reach up to 10⁻³A. In some embodiments, the current may reach up to 30 mA.

FIG. 5D illustrates two sets of data showing the current measured by the electrometer 406 as a function of the frequency of the drive voltage. The two sets of data depicted in FIG. 5D represent different bias voltages between the metal plate 102 and the collector 402. One set of the data represents the bias voltage 404 being set at +5V and one set represents the bias voltage 404 being set at −5V. There are only minor differences between the two sets of data, which suggests the presence of a substantial charge density in the air between the metal plate 102 and the collector 402. It is noted that the distance between the driver 104 and the resonator assembly 302 is set up differently in FIG. 5D than in FIGS. 5A-5C. Therefore, the peak frequencies and the magnitude of the current in FIG. 5D are not directly comparable to those shown in FIGS. 5A-5C. In FIG. 5D, the strongest emission line occurs at close to 36 MHz, which corresponds to the second order compressional mode of the resonator assembly 302.

In the above described embodiments, the vibrational energy of the metal plate 102 is converted into the electronic energy of the conduction charges in the metal plate 102. In some embodiments, the vibrational energy of the metal plate 102 may be converted into nuclear energy. In one embodiment, the metal plate 102 in the resonator assembly 302 is coated with mercury (Hg) to facilitate conversion of the vibrational energy into nuclear energy. It is known that a ²⁰¹Hg nucleus has an excited nuclear state that is1.5648 keV above the ground stable state (i.e., lowest energy nuclear transition). Through the interaction between the vibrational energy and the oscillating mercury nuclei, the vibrational quanta are converted into the nuclear energy of the ²⁰¹Hg nuclei. The ²⁰¹Hg nuclei are pumped onto the excited nuclear state. The excited ²⁰¹Hg nuclei undergo nuclear decay by exiting the excited state, which has a half-life of 81 ns (4 ms if only radiative decay occurs).

To prepare a mercury-coated metal plate 102, the first step is to plate mercury on the surface of the metal plate 102, e.g., a copper foil. Mercury ions readily diffuse into the copper foil, forming an amalgam. The foil is then treated with an oxidation-reduction process using a saturated Hg₂SO₄/H₂O solution. The Hg₂SO₄/H₂O solution is prepared by mixing an excess of Hg₂SO₄ in H₂O and stirring overnight. The mercury-plated copper foil is cleaned using acetone and de-ionized water, and then dipped into a diluted H₂SO₄ solution (with a pH value smaller than 1) for approximately one minute to remove the oxide. The copper foil is then rinsed with de-ionized water again. When both sides of the copper foil are coated with mercury, the copper foil is dipped into the saturated Hg₂SO₄ solution for approximately one minute and then rinsed with de-ionized water. If only one side of the copper foils is coated with mercury, the copper foil is laid flat on a glass surface and a cotton swap soaked with the saturated Hg₂SO₄ solution is used to wet the top surface of the copper foil. After approximately two minutes, the surface of the copper foil would show a pale white or silvery hue. The copper foil is then rinsed with de-ionized water and dried. The above oxidation-reduction reaction can be express as:

Hg²⁻+Cu=Hg+Cu²⁺.

In some embodiments, the mercury coated copper foil is used as the metal plate 102 in the resonator assembly 302. X-ray emissions are recorded by an X-ray detector when the resonator assembly 302 is connected to the driver 102 in a system set up similarly to that shown in FIG. 4. The signal generator 106 is configured to generate signals of a driving frequency 14.7 MHz. The drive voltage is set between 90 and 100 V rms. An X-ray spectrometer is used as a detector to detect X-ray emissions by the vibrating mercury-coated metal plate.

Because of the high driving frequency, the level of mechanical vibration may exceed the breakdown strength of air. To prevent air breakdown, the driver 104 is coated with a layer of Polyvinylidene Fluoride (PVDF). When the driver 104 is coated with PVDF, the driver 104 can be set up in contact with the metal plate 102, in which case the resonant frequency of the transverse mode of the resonator assembly 302 may be lower. For example, in the above described electron emission results shown in FIG. 5A, the emission near 15.1 MHz may be shifted to 14.7 MHz if the PVDF coated driver is used instead.

In some embodiments, X-ray emissions with energies between 1.34 keV and 1.6 keV are recorded by the X-ray detector. In one embodiment, the driver 104 is configured with round edges and the driving frequency is set to 14.7 MHz with a drive voltage of 90V rms. X-ray emissions are recorded near 1.34 keV. In one embodiment, the driver 104 is shaped with sharp edges and the driving frequency is set to 14.7 MHz with a drive voltage of 100V rms. X-ray emissions are recorded near 1.6 keV. In these embodiments, the distance between the driver 104 and the resonator assembly 302 varies from 40 microns to 0 microns when the PFDV coated drive 102 is in contact with the resonator assembly 302.

The observed X-ray emissions are due to nuclear decay of the excited ²⁰¹Hg nuclei. The nuclear energy gained by the ²⁰¹Hg nuclei when being pumped onto the excited state is derived from the quantized vibrational energy of the vibrating resonator plate 320. Through the interaction between the vibrational energy of the metal plate and the ²⁰¹Hg nuclei, the vibrational quanta are up-converted into nuclear energy.

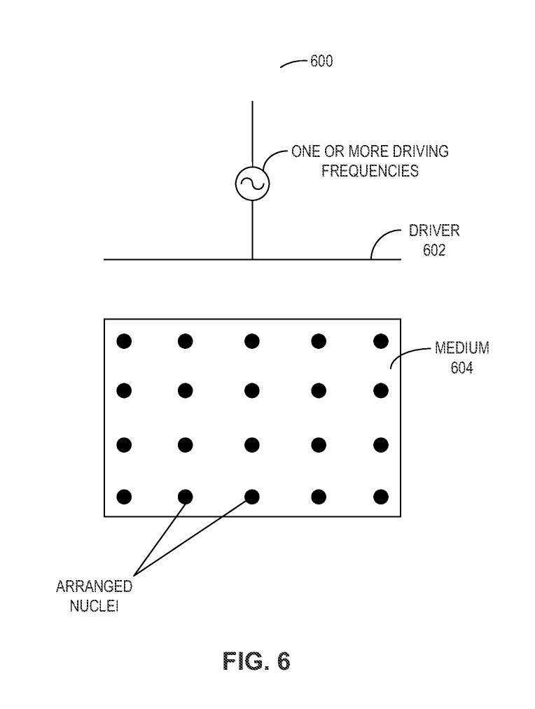

In the embodiments described above, vibrational quanta are up-converted into nuclear energy or electronic energy. Vibrational quanta can be down-converted as well. FIG. 6 illustrates an exemplary apparatus 600 configured to up-convert or down-convert vibrational quanta. The apparatus 600 comprises a driver 602 and a medium 604. The driver 602 is configured to generate oscillations of one or more driving frequencies. The medium 604 comprises arranged nuclei. The arranged nuclei are configured to oscillate at one or more oscillating frequencies when the medium is driven by the driver through a coupling mechanism. The coupling mechanism between the driver and the medium includes but is not limited to: mechanical forces, electromagnetic fields, optical phonons, acoustic waves, etc. The mechanical vibrational energy of the oscillating nuclei is quantized and the vibrational quanta in the oscillating nuclei are either down-converted or up-converted due to interaction between the mechanical vibrational energy of the oscillating nuclei and the oscillating nuclei.

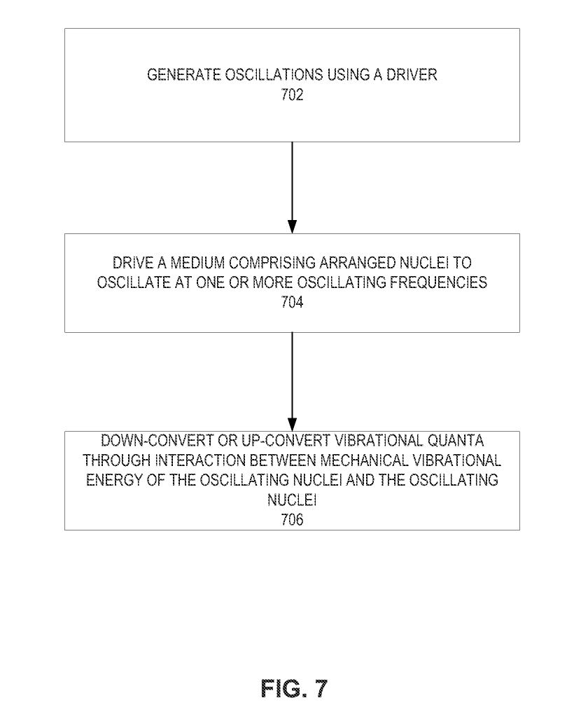

FIG. 7 illustrates an exemplary method of down-converting or up-converting vibrational quanta. The exemplary method comprises generating oscillations using a driver (step 702) and driving a medium comprising arranged nuclei to oscillate at one or more oscillating frequencies (step 704). Through interaction between the mechanical vibrational energy of the oscillating nuclei and the oscillating nuclei, the vibrational quanta are up-converted or down-converted (step 706).

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. An apparatus comprising:
a driver for generating oscillations; and
a medium comprising arranged nuclei configured to oscillate at one or more oscillating frequencies when the medium is driven by the driver, wherein vibrational quanta are either down-converted or up-converted due to interaction between vibrational energy of the oscillating nuclei and the oscillating nuclei, wherein, when the vibrational quanta are up-converted, the vibrational energy is converted to increase energy of conduction charges in the medium, and wherein one or more of the conduction charges overcome the surface energy barrier of the medium or become available for charge transfer to atoms or molecules in contact with a surface of the medium.

2. The apparatus of claim 1, wherein the oscillating nuclei comprise stable nuclei that can be excited onto one or more unstable states, and wherein, when the vibrational quanta are up-converted, the vibrational energy excites the stable nuclei to the one or more unstable states from which the excited nuclei undergo nuclear decay.

3. (canceled)

4. The apparatus of claim 1, wherein, when the vibrational quanta are down-converted, nuclear energy or electronic energy is converted to vibrational energy of the oscillating nuclei.

5. The apparatus of claim 1, wherein the oscillations generated by the driver are of one or more driving frequencies between 100 KHz and 50 THz.

6. The apparatus of claim 4, wherein the medium comprises a metal plate and the driver is connected to a signal generator via an amplifier, the signal generator generating a signal of a selected frequency;
wherein the signal generator, via the amplifier, applies a drive voltage between the driver and the metal plate, the drive voltage creating an electrostatic coupling between the driver and the metal plate; and
wherein the metal plate is induced to vibrate by the electrostatic coupling and wherein the vibrating metal plate is configured to emit the conduction charges that overcome the surface energy barrier of the metal plate.

7. The apparatus of claim 6, wherein the selected frequency is set to be one half of a resonant frequency of the metal plate and wherein the resonant frequency of the metal plate is associated with a compressional or transverse vibrational mode of the metal plate.

8. The apparatus of claim 6, wherein the metal plate is further attached to a resonator to arrange for a large number of nuclei to oscillate coherently.

9. The apparatus of claim 6, wherein the metal plate is connected to a collector that collects the charges emitted by the vibrating metal plate.

10. The apparatus of claim 6, wherein the metal plate is made of a metal selected from the group of copper, aluminum, nickel, titanium, palladium, tantalum, and tungsten.

11. The apparatus of claim 6, wherein the driver is connected to a copper pole for support, wherein the length of the driver is between 0.20-0.30 inches and the diameter of the driver is between 0.7-0.8 inches, the thickness of the metal plate is between 70-80 microns, and the distance between the driver and the metal plate is between 10-100 microns.

12. The apparatus of claim 8, wherein the driver is coated with Polyvinylidene Fluoride (PVDF) to prevent air breakdown, and wherein the distance between the driver and the metal plate is approximately 20 microns.

13. A method of converting vibrational quanta, comprising:
generating oscillations using a driver;
driving a medium comprising arranged nuclei to oscillate at one or more oscillating frequencies; and
down-converting or up-converting vibrational quanta due to interaction between vibrational energy of the oscillating nuclei and the oscillating nuclei, wherein the oscillations generated by the driver are of one or more driving frequencies between 100 KHz and 50 THz.

14. (canceled)

15. The method of claim 13, wherein the arranged nuclei comprise stable nuclei that can be excited onto one or more unstable states, and wherein the up-converting of vibrational quanta comprises exciting the stable nuclei onto the one or more unstable states from which the excited nuclei undergo nuclear decay.

16. The method of claim 13, wherein, when the vibrational quanta are up-converted, the vibrational energy is converted to increase the energy of conduction charges in the medium.

17. The method of claim 16, wherein the medium is a metal plate and one of the one or 5 more oscillating frequency is a resonant frequency of the metal plate, and wherein the vibrational quanta in the vibrating metal plate are up-converted into energy of conduction charges in the metal plate and the vibrating metal plate is configured to emit one or more of the conduction charges that comprise electrons or molecular ions.

18. The method of claim 17, further comprising collecting the one or more of conduction charges using a collector, wherein the conduction charges comprise electrons or molecular ions.

19. The method of claim 18, further comprising directing the collected charges to a confined region where a chemical reaction is taking place, to accelerate the chemical reaction.

20. (canceled)
